(19) United States
(12) Patent Application Publication
(10) Pub. No.: US 2018/0052956 A1
(43) Pub. Date: Feb. 22, 2018

(54) COMPUTER-ASSISTED EPISODE OF CARE CONSTRUCTION

(71) Applicant: KONINKLIJKE PHILIPS N.V., EINDHOVEN (NL)

(72) Inventors: MERLIJN SEVENSTER, CHICAGO, IL (US); Thusitha Dananjaya De Silva MABOTUWANA, BOTHELL, WA (US); Yuechen Qian, Lexington, MA (US); Kirk Spencer, Chicago, IL (US)

(21) Appl. No.: 15/552,999

(22) PCT Filed: Feb. 26, 2016
(86) PCT No.: PCT/IB2016/051068

§ 371 Date: Aug. 23, 2017

Related U.S. Application Data
(60) Provisional application No. 62/130,101, filed on Mar. 9, 2015.

(51) Int. Cl. G06F 19/00; G06F 17/30

(52) U.S. Cl. CPC G06F 19/322; G06F 19/3443; G06F 17/30716; G06F 17/30734; G06F 19/345

(57) ABSTRACT

When generating and editing episodes of care for patient, care events are grouped into episodes and stored in an episode of care database (14) that stores the episodes of care established for a patient. A data acquisition module (12) collects medical N events from one or more medical data systems, and an episode of care visualization module (16) displays to a user established episodes of care. An episode of care construction user interface (18) allows the user to create, extend and modify an episode of care in the episode of care visualization module. A grouping module (20) automatically creates episodes of care and presents suggestions to the user for extending established episodes of care with yet unrelated medical events.

The present invention finds application in patient healthcare data systems and methods. However, it will be appreciated that the described techniques may also find application in other document management systems, other data management techniques, and the like.

An episode of care is a defined period of illness that has a definite start and end date. During an episode of care, a patient may receive medical treatment, radiation therapy, surgical interventions, diagnostic tests and imaging exams amongst others. Condensing a multitude of medical events into meaningful episodes of care is extremely helpful for the busy clinician when mentally assembling the clinical history of a patient; for the administrator when analyzing the distribution of events over various episodes of care for financial optimization; and for the researcher when studying effectiveness of clinical interventions.

In conventional medical data systems, medical events are not semantically connected to overarching episodes of care. In this manner, for instance, it can be derived from one data system that an image-guided biopsy of the liver was conducted and from another data system that there was a pathology report three days later for the same patient. No meta-information is present reflecting the pathology report that discusses the outcome of the earlier biopsy. Lack of such meta-information prevents grouping of multiple heterogeneous events into episodes of care.

Typical methods for integrating and summarizing medical information must be accurate as they may influence clinical decision making when utilized in the workflow. Given the complexity of the problem, condensing multiple heterogeneous medical events into episodes of care is problematic given today's medical data persistence structures and/or information processing technologies.

A quality cardiac image read (e.g., US, CT, MM) integrates findings on the most recent exam with prior findings and diagnoses documented in prior reports of pertinent imaging studies, electronic medical records (EMR) and other information silos. Such information items may be documented narratively (e.g., free-text prose), in terms of controlled vocabulary (e.g., a value or statement selected from an exhaustive list of many options), as discrete values (e.g., measurements), or a combination thereof.

Treasure hunting information in disparate information silos is time consuming and workflow disruptive. For this reason, image-interpreting cardiologists are less inclined to search a disparate source of information (e.g., the interpretation report of a prior exam) if the cardiologist is under substantial time pressure or does not expect that the search will yield useful information (missing the “unknown known” conditions).

A select number of parameters are pertinent to the image-interpreting cardiologist, which may be documented in different styles (narrative, controlled items, discrete items) and across various reports. For certain parameters the trend over time is especially important. For instance, a low left ventricular ejection fraction is not worrisome if it has been stable over 5 years. Detecting the trend of a parameter over time requires consultation of reports finalized in the not-so-recent past. Mentally synthesizing the pertinent parameters and their trends over time is labor intensive and straining especially if it needs to be aggregated from heterogeneous information sources (e.g., MRI and US reports).

It has been reported in the literature that the reason for exam provided by the referring physician of an imaging exam is oftentimes incomplete to the point that the missing information is potentially diagnosis-altering and affecting care. Theoretically, radiologists can access disparate information silos to verify the information provided by the referring clinician and to complete gaps in their synthesis. This process is laborious as well as workflow-disruptive and is therefore often skipped.

The aggregation of patient background information consists of narrative content and is therefore hard to consume. Conventional tools do not discriminate between topics that are typically relevant for radiological interpretation (e.g., history of oncology) versus topics that are typically irrelevant (e.g., fever).

The present application provides new and improved systems and methods that facilitate generating and editing patient episodes of care, as well as categorizing care events, thereby overcoming the above-referenced problems and others.

In accordance with one aspect, a system that facilitates generating and editing episodes of care by grouping care events comprises an episode of care database that stores the episodes of care established for a patient. A processor is adapted to execute a data acquisition module that collects medical events from one or more medical data system, and an episode of care visualization module that displays to a user established episodes of care. The processor is further adapted to execute an episode of care construction user interface that allows the user to create, extend and modify an episode of care in the episode of care visualization module, and a grouping module that automatically creates episodes of care and presents suggestions to the user for extending established episodes of care with yet unrelated medical events.

According to another aspect, a system that facilitates normalizing and mapping extracted cardiologic data values according to severity and trending states comprises a processor adapted to execute a data collection module that queries one or more information databases for patient data and a document parsing module that recognizes a narrative structure of a given medical document. A parameter extraction module detects and extracts pertinent information from a parsed medical document, according to the study type, reason for exam, and disease model included in the medical document, and a parameter normalization module normalizes extracted parameters. A parameter out-of-normal-range detection module detects whether one or multiple values are out of their normal range, and a trend detection module that detects a trend in a series of time-stamped measurements or other normalized values. A visualization module that displays extracted pertinent parameters thereby allowing instant access to the source data where the parameters are discussed.

According to another aspect, a system that facilitates categorizing extracted data and visualizing high-level overviews of patient history comprises a processor adapted to execute a document parser module that parses out sections, paragraphs and sentences from medical narrative documents, and a concept extraction module that detects phrases and maps them to an external ontology. The processor is further adapted to execute a narrative context module that determines the status of an extracted phrase based on contextual information, and a categorization module that takes one or more extracted concepts and maps them to one or more pre-selected categories. The processor is further adapted to execute a visualization module that visualizes the categorical information computed from one or more medical narrative documents and is part of an information visualization application.

Still further advantages of the subject innovation will be appreciated by those of ordinary skill in the art upon reading and understand the following detailed description.

The drawings are only for purposes of illustrating various aspects and are not to be construed as limiting.

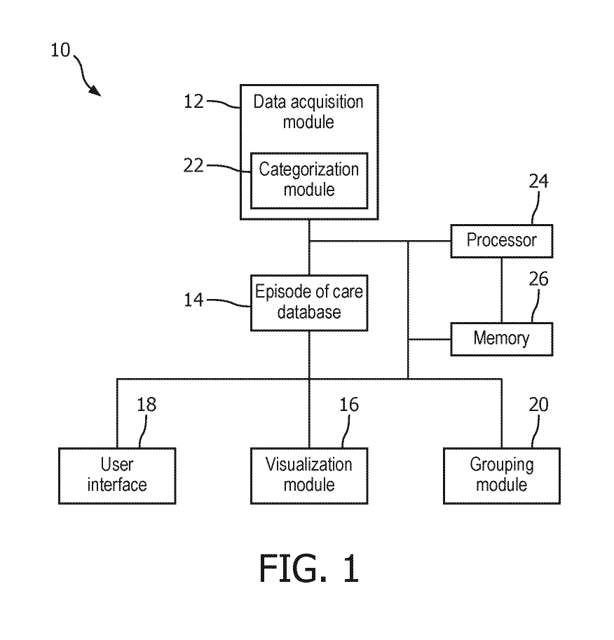

FIG. 1 illustrates a system that facilitates generating and editing episodes of care by grouping care events, in accordance with one or more aspects described herein.

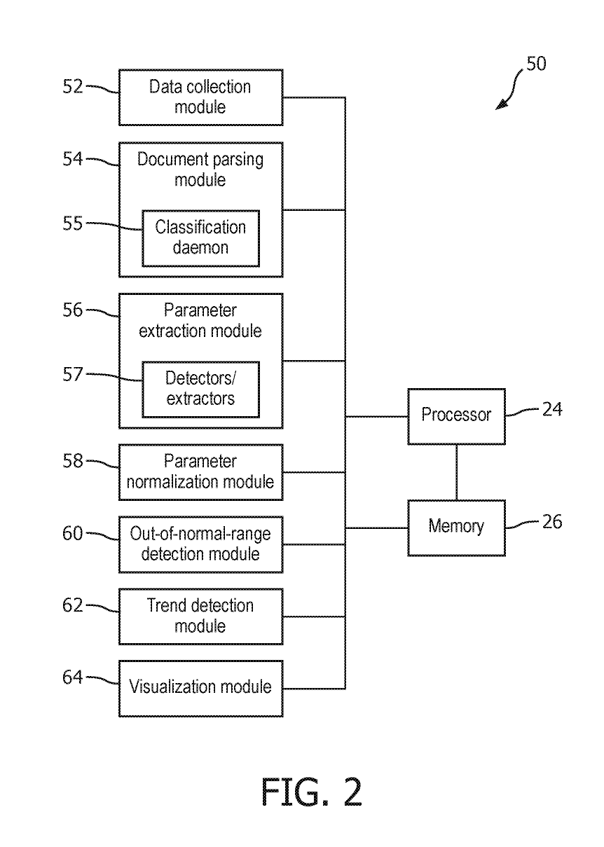

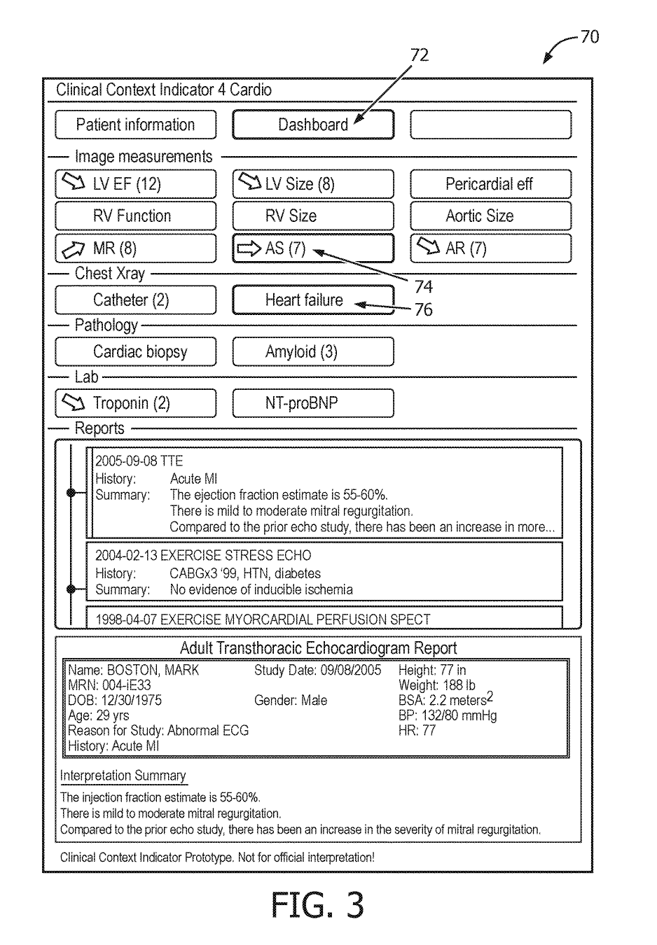

FIG. 2 illustrates a system that facilitates normalizing and mapping extracted data values according to severity and trending states, in accordance with various features described herein.

FIG. 1 illustrates a clinical context indicator interface, in accordance with one or more features described herein.

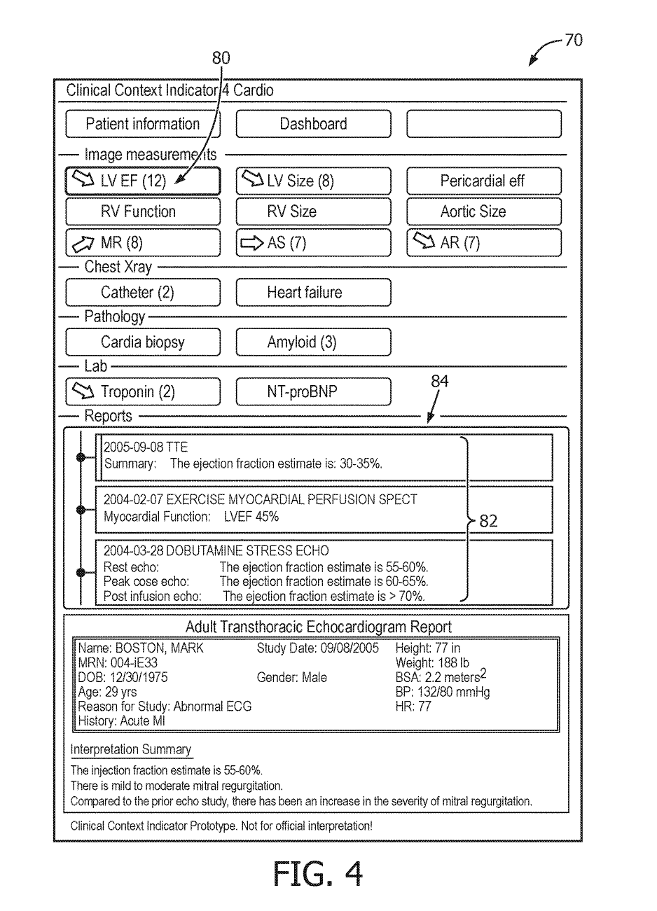

FIG. 4 shows the clinical context indicator interface, wherein the “LV EF” button 80 has been clicked.

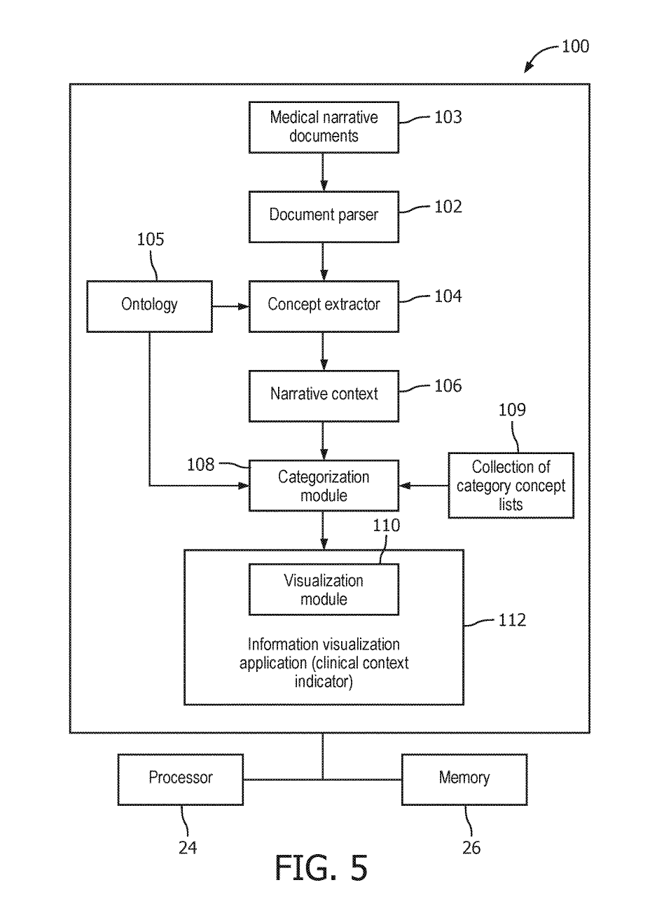

FIG. 5 illustrates a system that facilitates categorizing extracted data and visualizing high-level overviews of patient history, in accordance with various features described herein.

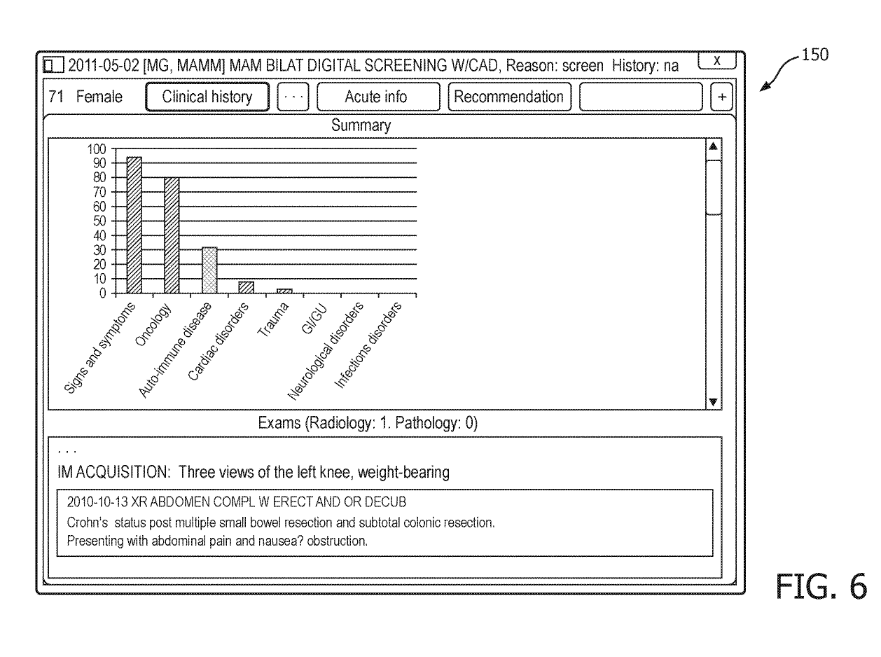

FIG. 6 illustrates a bar plot used to filter reports that contain information relevant to Crohn's disease.

The described systems and methods overcome the above-mentioned problems by automatically creating meaningful episodes of care by aggregating heterogeneous data sources. An episode of care is a defined period of illness that has a definite start and end date. During an episode of care, a patient may receive medical treatment, radiation therapy, surgical interventions, diagnostic tests and imaging exams amongst others. Condensing a multitude of medical events into meaningful episodes of care is extremely helpful for the busy clinician when mentally assembling the clinical history of a patient.

According to another embodiment, a system is provided for detecting and visualizing trends in series of normalized parameters in a dashboard view used by the image-interpreting cardiologist. The system allows instant access to data sources.

In another embodiment, narrative medical content is categorized and the output is presented in an intuitive and comprehensive manner. The visualization techniques allow for easy navigation to the source data and instant justification of the categorization results thereby facilitating synthesis of all relevant information by the radiologist.

FIG. 1 illustrates a system 10 that facilitates generating and editing episodes of care by grouping care events, in accordance with one or more aspects described herein. The system comprises a data acquisition module 12 that collects medical events from one or more medical data system, and an episode of care database 14 that stores the episodes of care established for a patient. An episode of care visualization module 16 visualizes and/or displays to a user established episodes of care. An episode of care construction user interface 18 is also provided to allow the user to create, extend or modify an episode of care in the episode of care visualization module. The system further includes a grouping module 20 that automatically creates meaningful episodes of care and brings suggestions to the user for extending established episodes of care with yet unrelated medical events. The system further includes a processor 24 that executes the described modules (e.g., computer-executable instructions, routines, applications, programs, etc.), and a memory 26 on which the modules are stored for execution by the processor.

The data acquisition module 12 accesses one or more medical data systems such as PACS, EMR and HL7 aggregators using standard Application Programming Interface (API) techniques. The data acquisition module queries the data sources for medical content pertaining to one patient, given the patient's unique identifier (e.g., Medical Record Number). The module includes a categorization module 22 that categorizes content, e.g., via a comprehensive data structure for imaging exams in which each imaging exam is modelled as an event with an anatomy (e.g., head/chest/abdomen/etc.) and modality (e.g., MR/CT/ultrasound/etc.) as well as other pertinent features.

The episode of care database 14 stores episodes of care as time intervals with a definite start and end date and containing one or more medical events collected by the data acquisition module 12. The database 14 also stores sub-episodes of care and all other elements that are required to construct the visualization presented by the episode of care visualization module 16. In one embodiment, the database 14 also stores all prior versions of the dataset and information as to who implemented what change as a logging trail.

The episode of care visualization module 16 visualizes (displays) the episodes of care persisted for a given patient. In one embodiment, the module 16 visualizes each episode of care as a horizontal bar element (e.g., with the x-axis representing time) in which separate medical events are denoted by icons. Episodes of care may also be represented as branching bars, for instance, to visually denote that one episode was the clinical consequence of another pre-existing episode of care (similar to a Gantt Chart). Episodes of care may also be represented as coalescing bars, for instance, to represent that several episodes of care are to be considered one henceforth. The visual devices for representing branching and coalescing episodes of care may be distinct depending on the nature of the non-linear pattern.

Each episode of care may further be subdivided into sub-episodes or stages. In this manner, a sub-episode may represent the diagnostic phase whereas others may present treatment and monitoring phases. Sub-episodes may be represented as horizontal bars within the main episode of care or marked by other visual features such as a vertical line in the horizontal bar of the main episode of care or a line connecting the bars of sub-episodes.

Each (sub)episode of care may be annotated with either a free-text description (e.g., “chemo after mastectomy”) or items from a controlled set of conditions (e.g., “diagnosis”, “treatment”, “monitoring”). In one embodiment, items from a controlled set of conditions enforce or suggest a default color or visual pattern for the visual element in which it appears.

The episode of care construction user interface 18 allows the user to create, delete, modify, merge and branch episodes of care using intuitive UI principles. According to an example, to create a new episode of care, a button marked “+” can be clicked. To delete an existing episode of care, the target episode of care can be selected. When the user makes a right mouse click a menu appears in which “Delete” is one selectable option. To merge two episodes of care, two episodes can be selected and a button “Merge” can be selected. Or alternatively, the user can drag and drop one episode onto another, or start a selection in one episode and end it in another. To branch an episode of care, the target episode of care can be selected. When the user makes a right mouse click a menu appears in which “Branch at ______” is one selectable option. This option has the date corresponding to time point selected in the place of “______”.

Sub-episodes of care can be managed in a similar manner using UI principles that are consistent with the principles for managing episodes of care. Medical events can be represented as individual icons on the timeline. Medical events can be grouped into, associated with and removed from episodes of care using intuitive UI principles. According to an example, to group multiple medical events into one new episode of care, the events can be selected. When the user makes a right mouse click a menu appears in which “Group in new episode of care” is one selectable option. To associate a medical event with an existing episode of care, the event icon can be dragged-and-dropped onto the episode of care. In another embodiment, multiple events can be selected and dragged-and-dropped at the same time. To remove an episode of care, it can be dragged-and-dropped from one episode of care into another or into the “neutral area” (relevant for ‘one-off’ type procedures—e.g., annual physical exam). In one embodiment, events cannot be removed from the timelines; in another embodiment, they can. Interaction between and within medical events and sub-episodes of care can be managed in a similar manner using UI principles that are consistent with the principles for managing interaction between medical events and episodes of care. All changes made to the episode and sub-episode of care system is persisted in the Episode of care database.

When a new medical event is detected, the grouping module 20 attempts to automatically create meaningful episodes of care by browsing active episodes of care and detecting potential similarities. The results are then presented to the user in an appropriate manner (e.g., sorted by a similarity score). The grouping module 20 establishes similarity between a medical event and the (sub)episodes of care based on automatically derived properties. For instance, the following features can be derived from an imaging exam event: modality (e.g., CR, CT, MRI, etc.); anatomy (e.g., Brain, chest, breast, etc.); etc.

In another embodiment, medical events that are associated with a narrative report (e.g., radiology, pathology, lab reports; oncology, surgery notes) can be automatically scrutinized for pertinent information using natural language processing and information extraction techniques. For instance, in this manner, a dedicated module can be used to extract the body location of the analyzed tissue biopsy (in case of pathology report). Using such properties, the new medical event can be matched against the one or more medical events that are grouped in one episode of care and the episode's unique information, such as its name. In one embodiment, a set of rules is used to match a new event with an episode of care. Examples of such rules may include: If the anatomy of a new medical event X is A and the episode of care Y contains at least one event with anatomy A, then there is a match between X and Y; If the anatomy and modality of a new imaging study X is (A, B) and the episode of care Y contains at least one imaging study with similar anatomy and modality, then there is a match between X and Y; If the anatomy and modality of a new imaging study X is (A, B) and the episode of care Y contains at least one imaging study with similar anatomy and modality and Y's date is not more than 1 year older than the new medical event, then there is a match between X and Y; etc. In yet another embodiment, machine-learning or statistical methods are used for matching. In an advanced embodiment, a self-learning method is used based on manually established medical eventepisode of care associations as ground truth data.

The grouping module 20 can also present a list of matching episodes of care for each new medical event created since the user last opened the application. The user can then select one of the matching episodes. In another embodiment, user input is only asked if the confidence of the match (e.g., produced by a machine-learning or statistical module or the like) is lower than a pre-determined threshold. In another embodiment, the grouping module automatically assigns a new medical event to one episode of care.

It will be understood that the processor 24 executes, and the memory 216 stores, computer executable instructions for carrying out the various functions and/or methods described herein. The memory 26 may be a computer-readable medium on which a control program is stored, such as a disk, hard drive, or the like. Common forms of computer-readable media include, for example, floppy disks, flexible disks, hard disks, magnetic tape, or any other magnetic storage medium, CD-ROM, DVD, or any other optical medium, RAM, ROM, PROM, EPROM, FLASH-EPROM, variants thereof, other memory chip or cartridge, or any other tangible medium from which the processor 24 can read and execute. In this context, the described systems may be implemented on or as one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics processing unit (GPU), or PAL, or the like.

FIG. 2 illustrates a system 50 that facilitates normalizing and mapping extracted data values according to severity and trending states, in accordance with various features described herein. The system includes a data collection module 52 that queries pertinent information silos for pertinent data, and a document parsing module 54 that recognizes the narrative structure of a given medical document. The system also comprises a parameter extraction module 56 that detects and extracts pertinent information from a parsed medical document, according to the study type, reason for exam, and disease model. For instance, parameters may include: parameters across modalities such as left ventricle ejection fraction (LVEF), left ventricle size, right ventricle function, right ventricle size, aortic stenosis severity, aortic regurgitation severity, mitral regurgitation severity, pericardial effusion size, aortic size, etc.; parameters across ultrasound (US) such as left ventricle hypertrophy, mitral stenosis severity, tricuspid regurgitation severity, left atrial size, right atrial size, IVC size, diastolic function, pulmonary artery size, etc.; general demographics such as age, sex, height, weight, prior cardiac surgeries, etc. These parameters may be described in various formats depending on the modality. For instance, the Right ventricle function parameter is persisted as discrete data points in MR reports but narratively in US and CT reports.

A parameter normalization module 58 is provided which normalizes extracted parameters. The system further comprises a parameter out-of-normal-range detection 60 that detects if one or multiple values are out of their normal range, possibly correlated with the trend detected earlier. A trend detection module 62 detects a trend in a series of time-stamped measurements or other normalized values. A visualization module 64 that displays extracted pertinent parameters allowing instant access to the source data where the parameters are discussed. The system further includes a processor 24 that executes the described modules (e.g., computer-executable instructions, routines, applications, programs, etc.), and a memory 26 on which the modules are stored for execution by the processor.

The data collection module 52 collects electronic documents associated with a given a patient using a unique identifier by means of standard application programming interface techniques. In one embodiment, the search is refined to retrieve only documents of a certain type (e.g., anatomy, imaging modality, medical specialty or time interval).

The document parsing module 54 can be implemented in various manners anticipating the structure of the source data retrieved by the data collection module 52. In one embodiment, the structure of each document type (e.g., transthoracic echo report finalized after 31 Jan. 2008) is known and the document parsing module can route it to the appropriate submodule for parsing. In another embodiment, the structure of or more document types are unknown. In this embodiment, a classification daemon 55 decides on the most appropriate parsing submodule. This daemon may take into account readily detected properties such as the presence of xml tags. The daemon may then compare the found xml tags against various known templates that are labelled with document type.

The output of the parsing module is a mapping of fragments of input documents to controlled list of items modelling their narrative roles (e.g., introduction, LV ejection fraction, patient history, etc.) persisted in an appropriate format. Note that the controlled list of items may vary per document type; it models the values anticipated to sit in the report. If data is pre-structured using xml tags, the parsing module may leverage the xml nodes to map report fragments to controlled items. For instance, the xml tags can be used to map the fragment the phrase “No mass or thrombus is noted in the LA or LAA. No mass or thrombus seen in the right atrium or right atrial appendage.” to the controlled item “Atria” in an Anatomy-specific information code snippet (see below).

If the data is not pre-structured, alternative methods can be used to map text fragments to controlled items. In one embodiment, a rule-based parser is used that recognizes section and paragraph headers from a list of known header. In another embodiment, a statistical or machine-learning method is used that aggregates various contextual features and determines if a certain string is a section or paragraph header. The document parsing module 54 also detects end of sentence boundaries in multi-sentence text fragments using known techniques. For instance, maximum entropy techniques, rule-based techniques, etc., may be employed.

The parameter extraction module 56 manages a set of detector/extractor submodules 57, one for each pertinent parameter. Each submodule is equipped to detect if its parameter is mentioned in a narrative context and/or in a structured format. The parameter extraction module also knows where to search for the parameters in the medical document labelled by the Document parsing module. For instance, the ejection fraction is reported in the section pertaining to the left ventricle. This module automatically selects the “Left ventricle” section of the document for scrutiny. As another example, prior heart surgery is typically reported in the “Patient history” section.

In one embodiment, to detect mentions in free text, methods can be leveraged based on pattern-recognition techniques (e.g., regular expressions). In addition, pre-processing techniques can be used to format the input text in well-behaved format, for instance by chunking up the narrative fragment in words. Once detected, the extraction component of the submodule 57 retrieves the relevant string from the report but maintains relevant meta-data, such as character position in the source document. The code snippets below show Interpretation Summary information stored in xml-format and anatomy-specific information stored in xml-format, respectively.

Interpretation Summary information stored in xml-format:

```
<p><div CLASS=“section”><u>Interpretation Summary</u></div>
  A Transesophageal examination was performed. A color Doppler examination was performed. Informed consent was
  obtained. ECG, pulse rate, respiratory rate, blood pressure and pulse oximetry were monitored. The patient
  was placed in the left lateral decubitus position. Conscious sedation was achieved with a combination of
  intravenous Fentanyl and Versed. The patient was intubated without difficulty and tolerated the procedure
  well without complication. There is no comparison study available.
<p>The SBP during the procedure was 140-150 mmHg, the heart rate was 90-100 BPM. <br>The mitral valve is
structurally normal.<br>There is mild mitral regurgitation.<br>
```

Anatomy-specific information stored in xml-format:

<br><div CLASS=“section”><u>Atria</u></div> No mass or thrombus is noted in the LA or LAA. No mass or
thrombus seen in the right atrium or right atrial appendage.
<br><div CLASS=“section”><u>Mitral Valve</u></div> The mitral valve is structurally normal. There is mild
mitral regurgitation. The SBP during the procedure was 140-150 mmHg, the heart rate was 90-100 BPM
<br><div CLASS=“section”><u>Tricuspid Valve</u></div> The tricuspid valve is structurally normal. There is
trace tricuspid regurgitation.
<br><div CLASS=“section”><u>Aortic Valve</u></div> The aortic valve is tri-leaflet. There is no significant
aortic stenosis. No significant aortic regurgitation is present.
<br><div CLASS=“section”><u>Pulmonic Valve</u></div> The pulmonic valve is normal in structure. There is no
significant pulmonic valvular regurgitation.
<br><div CLASS=“section”><u>Vessels</u></div> The aortic root is normal in size. No significant atheromatous
disease of the ascending aorta or aortic arch. No significant atheromatous disease of the descending aorta.
<br><div CLASS=“section”><u>Pericardium</u></div> There is no pericardial effusion.

When determining the anatomy-specific information, the detector/extractor submodule 57 for “Aortic stenosis” knows to search the “Aortic valve” section of the report, and detects the pertinent mention in the sentence “There is no significant aortic stenosis.” and extracts “no significant” accordingly.

In another embodiment, parameter ranges (e.g., “50-60%”) are detected and extracted as more complex data types that encompass a lower and an upper limit. Additionally or alternatively, in case the detector part of the submodule detects a pertinent string but the extractor module cannot extract it, the phrase is flagged and a null-value is extracted.

In another more advanced embodiment, the parameter extraction module 56 incorporates the context information of the study, e.g. modality, reason for exam, and underlying disease models, and performs information extraction accordingly. The system creates a mapping between the study modality of reports and relevant parameters that might be mentioned in reports. For echocardiogram reports, the system extracts for instance left ventricle hypertrophy, mitral stenosis, left atrium, tight atrium, and so on. For MR reports, the system extracts left ventricle ejection fraction (LV EF), left ventricle size, right ventricle function, right ventricle size and so on. The system extracts the modality information from the DICOM header of the study and use the predefined map to determine a set of parameters to be extracted from report.

The parameter normalization module 58 normalizes extracted values with respect to an appropriate system of real values (e.g., measurements) or list of controlled items (e.g., aortic stenosis severity). Numerical values (e.g., “45%”) are readily normalized from the document. Free-text values can be normalized using a mapping table (e.g., “no significant”→“normal”). In one embodiment, the null-value found by the Parameter extraction module is mapped to the field “unknown”. In another embodiment, the document type is taken into account. In this manner, an ejection fraction of 55% may be regarded as “normal” when extracted from a US report but “mild” when extracted from an MM report.

The parameter out-of-normal-range-detection module 58 accepts a normalized value and returns an item from a controlled list that models whether the value is normal or not. As an example, a standard list of modelling normality of an input value is: “normal”, “mild”, “moderate”, “severe”. In one embodiment, ranges are known for numerical values that defines each item on the controlled list. For instance, an ejection fraction of 55% would be mapped to the value “normal”, whereas an ejection fraction of 40% would be mapped to “mild”. In another embodiment, value ranges can also be mapped to items of the controlled list. In one implementation, the extreme values are mapped individually and the more “non-normal” value is used as normalized value representing the range. In this, manner, for instance, “45-55%” would be mapped to “mild”, considering that 45→“mild” and 55→“normal”.

The trend detection module 60 accepts a time-stamped series of normalized values and returns a trend value that is either a real value representing percentage change (e.g., “15.4” representing 15.4% increase or “−9.8%” representing 9.8% decrease) or an item from a controlled list (e.g., “stable” or “minor increase”). In the case of all-numerical values (T[−k], T[−k+1], T[0]), a trend can be observed by comparing the numerical values. In this manner, an “increase” trend can be called if the last N values are increasing, where N>1 is some pre-determined value. In another implementation, the percentage change between, for example:

T[−1],T[0]; and

T[−4],T[−3],T[−2]

is computed to model the trend between T[0] and T[−3]. In the above computation, the next and previous values can be used to smooth abrupt changes. In other implementations, the more or fewer surrounding values can be taken into account.

If at least one value is not numerical, all values can be mapped to their normalized normality value computed by the parameter out-of-normal-range detection module. Then, a rule-based method can used to determine the trend. For instance, one sample rule postulates that: If the normalized value at T[−1] is less severe than that of T[0], then the trend is marked as “increase”.

Note that the trend detection module allows for comparison of heterogeneous information pulled from various document types and documented in either narrative or discrete format. In an another embodiment, if one of the normalized values is “unknown” and the trend is either “normal” or “mild”, the entire trend is set to “unknown”. Alternative implementations can be chosen to handle unknown values.

The visualization module 62 displays pertinent information for each parameter. In one embodiment, the user interface visualization reserves one button or field for every parameter. The parameter can be automatically equipped with various information such as a highlighted button indicating what is selected. The information may also include an arrow representing the trend detected by the trend detection module. In the case of percentage change (“15%”), the angle of the arrow can be drawn proportionally to the percentage change. In the case of discrete trend information (“mildly increased”) a fixed angle can be chosen. If the trend is marked as unknown, an appropriate visualization can be selected such as a question mark instead of an arrow.

The information can also include a color of the button or the one or more visual elements associated with the parameter's button or field that represents the normality. For instance, the value “severe” would be associated with the red color; “moderate” with orange; and “mild” with yellow. Other, more appropriate color schemes can be used depending on the nature of the parameter. In one implementation, the trend arrow is colored. If the trend is unknown, a color may be selected to reflect this, such as gray. Additionally or alternatively, the information can include a numerical value representing the number of hits found by the Parameter extraction module in unique reports. This information can be displayed using standard web methods.

In one embodiment, the appropriate user interaction principles apply. For instance, when the user clicks a parameter button, all sentences in which the parameters were discussed are shown to the user. In another embodiment, only unique sentences are shown. Extracted and normalized phrases or values can be colored or highlighted so as to stand out, potentially using the same coloring scheme that was used to color the button.

In another embodiment, the (normalized) values of a parameter are plotted on a timeline. In a related embodiment, there is one timeline panel in which one or more parameters are plotted with their respective trend information displayed. Every time the user selects a new parameter, the corresponding values or shown on the timeline.

FIG. 2 illustrates a clinical context indicator interface 70, in accordance with one or more features described herein. The general “Dashboard” tab 72 is selected which gives a dashboard view on pertinent parameters and a general timeline overview on prior narrative reports. Arrows and colors inside the parameter buttons reflect trend and out of normal range information. The gray arrow 74 for “AS” indicates that at least one value could not be extracted or normalized. The user may want to check the value for him or herself. Note that in this interface, information from image measurements, non-cardiac imaging, pathology and lab reports are combined into one visual dashboard. The low-lighted buttons 76 indicate that no hits were found for these parameters. Clicking these buttons would yield an empty “Reports” panel.

FIG. 4 shows the clinical context indicator interface 70, wherein the “LV EF” button 80 has been clicked. A timeline 82 of report snippets now shows 12 unique reports and only sentences pertaining to the LV ejection fraction, indicated by the “(12)”. The trend is decreasing and at least one prior value is in severe state, witnessed by the down-facing red arrow in the button. In the “Reports” panel 84 only sentences pertaining to the LV EF are shown with extracted non-normal values colored and shown in bold face. When a report snippet is selected in the “Reports” panel, the original report is shown at the bottom page. Sentences and values van also be highlighted in the bottom panel.

FIG. 5 illustrates a system 100 that facilitates categorizing extracted data and visualizing high-level overviews of patient history, in accordance with various features described herein. The system comprises a document parser module 102 that parses out sections, paragraphs and sentences from medical narrative 103, and a concept extraction module 104 that detects phrases and maps them to an external ontology 105. The system further includes a narrative context module 106 that determines the status of an extracted phrase based on contextual information, and a categorization module 108 that takes one or more extracted concepts and maps them to one or more pre-selected categories 109. The system further comprises a visualization module 110 that visualizes the categorical information computed from one or more medical narrative documents and is part of an information visualization application 112 (e.g., a clinical context indicator or the like). The system further includes a processor 24 that executes the described modules (e.g., computer-executable instructions, routines, applications, programs, etc.), and a memory 26 on which the modules are stored for execution by the processor.

The document parser module 102 recognizes section and paragraph headers in medical narrative documents and potentially normalizes them with respect to a pre-determined set of section (e.g., “Impression”) and paragraph (e.g., “Liver”) headers. This module can be implemented using rule-based or machine learning techniques. A state-of-the-art module uses a maximum entropy model, which is essentially based on statistical techniques.

The concept extraction module 104 recognizes phrases in free-text sentences and maps them to an external ontology, such as SNOMED, UMLS, RadLex, or MetaMap.

The narrative context module 106 determines the status of a recognized phrase. For instance, in the following examples, the semantics of the underlined phrases are modified by the context in which they appear: “There is no evidence for recurrent metastases . . . ” The underlined phrase is effectively negated; “Evaluate for pulmonary embolism . . . ” The underlined phrase is to be assessed and is neither confirmed nor disconfirmed; “History of traumatic brain injury . . . ” The underlined phrase appeared in the past. This module can be based on expression-based methods. For instance, it can be stipulated that every phrase that appears at most three words to the right from the string “history of” occurred in the past. Such methods have been found to be very effective in the field in medical language processing (e.g., “NegEx”).

The categorization module 108 accepts one or more concepts and aims to associate them with one or more pre-determined categories. For instance, categories that are relevant to CCI users include: Oncology; Auto-immune disorders; Congenital disorders; Cardiac disorders; Infectious disorders; Metabolic disorders; Signs and symptoms; Trauma and injury; Neurological disorders; Respiratory/thoracic disorders; GI/GU disorders; Musculoskeletal disorders; etc. In one embodiment, the categorization module 108 maps one concept to one or more of these pre-determined categories. In one implementation, the module maintains a list of concepts that model each of the pre-determined categories. If the one concept is found on any of the category's lists of concept, it is associated with the category. In another implementation, a list of representative concepts is maintained per category and a sub-module tries to establish a semantic relation between the one input concept and the list of representative concepts through the ontology's relations.

A relation is typically a directed association between two ontology concepts. For instance, “Left kidney” is-a “Kidney”, “Renal cyst” has-finding-site “Kidney” and “Pons” is-part-of “Brainstem”. The relations can be traversed iteratively: “Left kidney” is-a “Kidney” (has-finding-site-reversed) “Renal cyst” and “Pons” is-part-of “Brainstem” is-part-of “Brain”. Special logic can be applied to restrain the iterative traversal of concepts. For instance, it can be stipulated that only the is-a relation may be traversed; or that first any number of is-a relations may be traversed, then one has-finding-site relation, and then again any number of is-a relations.

When a there is way of traversing the ontology from the one input concept to one of the category's representative concepts respecting the traversal logic in effect, the concept is considered to belong to that category. In another embodiment, multiple input concepts are categorized as a whole. This can be realized by obtaining the categories for each individual concept in the list of input concepts and aggregating the outcome. Potential aggregation methods include concluding that a list of concepts belongs to a certain category, if: at least one of the list's concepts is associated with that category; a majority of the list's concepts are associated with that category; or all the list's concepts are associated with that category.

In another embodiment, the list of category concepts is externally configurable so that the user can manipulate what belongs to a certain category and what not by modifying the list files. In another embodiment, the user can add a category by adding a new list of concepts. The categorization module can consume all lists it finds in its input location and determines categorical associations simply based on the contents of the lists.

The visualization module 110 presents the categorization results that is intuitively and comprehensively integrated with the source narrative, possibly integrated into another application, such as a Clinical Context Indicator. In one embodiment, the categorization results are shown as bar plots in which each bar represents a category and the size of the bar is determined by the (relative) number of sentences or reports associated with the category.

FIG. 6 illustrates a bar plot 150 used to filter reports that contain information relevant to Crohn's disease. The first bar indicates that 95% of prior medical narrative contains at least one sentence that is associated with a signs and symptoms concept. It can be enforced that only concepts are categorized that were mapped to from phrases that have a certain status in the narrative context per the narrative context module. For instance, it can be determined that only un-negated concepts are used for categorization.

In another UI embodiment, the user can hoover the mouse over each bar and view snippets of text that are associated with the category at hand. This gives an instant no-click impression of the patient's clinical history. In another advanced embodiment, each bar can be clicked, which functions as a filter on the content displayed by the tool in which it is integrated, such as CCI. In this embodiment, a timeline representation displays the snippets of text that were associated with the selected category by the categorization module.

In yet another embodiment, the user can give feedback to the system. To this end, the phrase from which a particular concept was extracted may be underlined using standard and well-known visualization technique. When the user hovers over the underlined phrase, a pop-up appears with information regarding the extracted concept and its category. In this pop-up, the user can indicate that the concept actually does not belong to the category. This information can be logged for refining the behavior of the Categorization module either manually or automatically.

The innovation has been described with reference to several embodiments. Modifications and alterations may occur to others upon reading and understanding the preceding detailed description. It is intended that the innovation be construed as including all such modifications and alterations insofar as they come within the scope of the appended claims or the equivalents thereof.

1. A system that facilitates generating and editing episodes of care by grouping care events, comprising:
an episode of care database that stores the episodes of care established for a patient;
a processor adapted to execute:
a data acquisition module that collects medical events from one or more medical data system;
a narrative report extraction module that extracts pertinent data and phrases from narrative medical reports contained within the one or more medical data systems;
an episode of care visualization module that displays to a user established episodes of care; and
an episode of care construction user interface that allows the user to create, extend and modify an episode of care in the episode of care visualization module.

2. The system according to claim 1, further comprising a grouping module that automatically creates episodes of care and presents suggestions to the user for extending established episodes of care with yet unrelated medical events.

3. The system according to claim 2, wherein the grouping module is further adapted to present a list of matching episodes of care for each new medical event created since the user last opened the application.

4. The system according to claim 3, wherein the processor is further adapted to receive input describing a user selection of one of the matching episodes.

5. The system according to claim 3, wherein the processor is further adapted to receive input indicating whether the confidence of the match is lower than a pre-determined threshold

6. The system according to claim 3, wherein the grouping module automatically assigns a new medical event to an existing episode of care.

7. The system according to claim 1, wherein, when a new medical event is detected, the grouping module automatically creates episodes of care by browsing active episodes of care and detecting potential similarities.

8. The system according to claim 1, wherein the episode of care visualization module displays the episodes of care persisted for a given patient.

9. The system according to claim 8, wherein the episode of care visualization module presents each episode of care as a horizontal bar element, with an x-axis representing time, in which separate medical events are denoted by icons.

10. The system according to claim 8, wherein the episode of care visualization module represents episodes of care as branching bars, in order to visually denote that one episode was the clinical consequence of another pre-existing episode of care.

11. The system according to claim 8, wherein the episode of care visualization module represents episodes of care as coalescing bars such that coalesced episodes of care are subsequently represented as a single episode of care.

12. A system that facilitates generating and editing episodes of care by normalizing and mapping extracted data values according to severity and trending states, comprising:
an episode of care database that stores the episodes of care established for a patient;
a processor adapted to execute:
the a data collection module that queries one or more information databases for patient data;
a document parsing module that recognizes a narrative structure of a given medical document;
a parameter extraction module that detects and extracts pertinent information from a parsed medical document, according to study type, reason for exam, and disease model included in the medical document;
a parameter normalization module that normalizes extracted parameters;
a parameter out-of-normal-range detection module 60 that detects whether one or multiple values are out of their normal range;
a trend detection module that detects a trend in a series of time-stamped measurements or other normalized values; and
a visualization module that displays extracted pertinent parameters thereby allowing instant access to the source data where the parameters are discussed; and
user established episodes of care; and
an episode of care construction user interface that allows the user to create, extend and modify and episode of care in the visualization module using extracted pertinent parameters.

13. The system according to claim 12, further comprising a clinical context indicator interface having a dashboard tab that, when selected, presents a dashboard view of patient parameters and a timeline overview on prior narrative reports.

14. The system according to claim 13, wherein the clinical context indicator interface comprises a plurality of selectable parameter icons, and wherein upon selection of a parameter icon, a timeline of report snippets displayed comprising extracted sentences pertaining to the selected parameter.

15. The system according to claim 14, wherein extracted sentences pertaining to the selected parameter are shown with extracted non-normal values colored and shown in bold face.

16. The system according to claim 14, wherein the clinical context indicator interface indicates whether the selected parameter is trending upward or downward and whether at least one prior value of the parameter has been determined to be in a severe state.

17. A system that facilitates generating and editing episodes of care by categorizing extracted data and visualizing high-level overviews of patient history, comprising:
an episode of care database that stores the episodes of care established for a patient;
a processor adapted to execute:
a document parser module that parses out sections, paragraphs and sentences from medical narrative documents;
a concept extraction module that detects phrases and maps them to an external ontology;
a narrative context module that determines the status of an extracted phrase based on contextual information;
a categorization module that takes one or more extracted concepts and maps them to one or more pre-selected categories; and
a visualization module that visualizes the categorical information computed from one or more medical narrative documents and is part of an information visualization application and displays user established episodes of care; and
an episode of care construction user interface that allows the user to create, extend send modify an episode of care in the visualization module using extracted categorical information.

18. The system according to claim 17, wherein the categorization module accepts a concept phrase and associates the concept phrase with one or more pre-determined categories.

19. The system according to claim 18, wherein the categorization module maps one the concept phrase to one or more of pre-determined categories.

20. The system according to claim 18, wherein the categorization module maintains a list of concept phrases that model each of the pre-determined categories, and wherein upon identifying the concept phrase on any of the category's lists of concepts, the concept phrase is associated with the category.

21. The system according to claim 18, wherein the categorization module maintains a list of representative concepts per category establishes a semantic relation between the concept phrase and the list of representative concepts through the ontology's relations.
